(19) United States
(12) Patent Application Publication
(10) Pub. No.: US 2015/0004329 A1
(43) Pub. Date: Jan. 1, 2015

(54) SHORT-TIME GROWTH OF LARGE-GRAIN HEXAGONAL GRAPHENE AND METHODS OF MANUFACTURE

(71) Applicant: King Abdulaziz City for Science and Technology, Riyadh (SA)

(72) Inventor: Hatem Abuhimd, Riyadh (SA)

(21) Appl. No.: 13/930,823

(22) Filed: Jun. 28, 2013

(51) Int. Cl. C01B 31/04; C25F 3/22

(52) U.S. Cl. CPC C01B 31/0453; C25F 3/22; C01B 2204/22; C01B 2204/24; C01B 2204/26
USPC 427/551; 427/249.6; 205/661

(57) ABSTRACT

The disclosure is relates to nanotechnology and nanofabrication of few-crystal hexagonal graphene. The method includes contacting a copper film with a gas. The method further includes raising a temperature of the copper film to about 1000° C. over of period of about 40 minutes. The method further includes heating the copper film at about 1000° C. for a period of about 1 hour. The method further includes contacting the copper film with a carbon-containing gas for about 5 minutes. The method further includes cooling the copper film to room temperature to produce a graphene layer on the copper film.

### FIELD OF THE INVENTION

The present invention relates to nanotechnology and nanofabrication and, more particularly, to nanotechnology and nanofabrication of few-crystal hexagonal graphene, e.g., five (5 layers).

### BACKGROUND OF THE INVENTION

Graphene is an allotrope of carbon whose structure is a planar sheet of sp²-bonded carbon atoms. It is a two-dimensional nanomaterial with a honeycomb lattice arrangement having unique physical properties. For example, graphene can sustain current densities six orders of magnitude higher than metals, like copper, it is thermally conductive, impermeable to gases and ductile. Furthermore, graphene has excellent transparency and mechanical flexibility. Graphene can be referred to as single-layer graphene, two-layer graphene, multi-layer graphene, and the like, depending on the number of layers.

Some methods for producing graphene particles and materials have been developed and their use in applications, such as nanotube production and use in electrodes and circuits is currently being explored. In fact, it has been found that graphene has utility in many practical applications, such as in the production of membranes for sensing pressure and chemicals, and for making components in nanoelectromechanical systems. Due to its unique properties, graphene can also be used to make transistors that run at higher frequencies and more efficiently than current silicon transistors. The electronic properties of graphene can also be influenced by gas molecules, allowing it to act as a chemical sensor. Graphene can also be potentially used as a thin protective coating in order to protect against agents, such as acids and alkalis, because of its resistance to these agents. Additional applications of graphene materials include use in lithium ion batteries, supercapacitors, and catalyst supports.

One method for making graphene is a drawing or peeling method, whereby graphene is obtained by mechanical exfoliation of graphite. An adhesive material, for example an adhesive tape, is typically used to peel off the layers. This method suffers from the difficulties that residues of adhesive used to peel the layers of graphite can result in mobility degradation. In addition, the size of the graphene flakes obtained by the mechanical exfoliation method is limited. This also tends to be a very time-intensive method.

Another method reported for making graphene involves hydrazine reduction, whereby graphene oxide paper is added to a solution of hydrazine or some other appropriate reducing agent, which reduces the graphene oxide to graphene. The graphene oxide can be formed, for example, by reacting graphite with strong acids and oxidants. This method produces graphene flakes of different lateral sizes and thicknesses. Unfortunately, the reduction method can result in modification of the original sp² network of carbon atoms and the scalability of the method to wafer scale is challenging.

Another method involves producing graphene ribbons from cutting open nanotubes, one of the dimensional analogues of graphene. Most important properties of this method are contained in specific edge orientation; however, there is difficulty in obtaining nanoribbons with precise edges.

Graphitization of silicon carbide is another method for producing graphene which has been reported in the literature. Silicon carbide, when heated at around 1400° C. under vacuum results in the sublimation of silicon and resulting graphitization of the remaining carbon. However, this method results in a highly corrugated surface covered by small graphene regions with varying thickness. In addition, the initial cost of the SiC wafer is high and the method requires very high temperatures of around 1400-1600° C.

Yet another technique involves epitaxial growth on metal substrates, whereby the atomic structure of a metal substrate is used to seed the growth of graphene from a carbon source. The essence of this technique is that carbon-containing precursors in a vapor phase adsorb and react at the substrate surface, resulting in the deposition of a thin film as a result of chemical reaction. The reaction at the substrate surface may occur at elevated temperatures and under low or atmospheric pressure. Transition metals can serve as efficient catalysts in forming graphitic materials from hydrocarbons. This technique is often referred to as chemical vapor deposition, or CVD.

When using graphene in electronic applications, field effect mobility, transmittance, and sheet resistance are important parameters. CVD grown graphene from the literature shows field effect mobilities on the order of 3000 cm²/Vs, optical transmittance on the order of 90% and sheet resistance of the order 280Ω/sq. Graphene obtained by CVD having the above parameters is inferior to graphene obtained by mechanical exfoliation. One reason is that graphene obtained by CVD is in the form of a continuous sheet which is inherently polycrystalline because graphene domains of different orientations merge together to form a graphene sheet. Because of the presence of these grain boundaries, the overall film can exhibit reduced electrical properties. As grain boundaries have been found to impede both electrical and mechanical properties of graphene, it would be desirable to synthesize large-grain, single crystalline graphene using CVD for various applications. Such a development would overcome the deficiencies and limitations described hereinabove.

### SUMMARY OF THE INVENTION

A first aspect of the invention involves a method for making graphene, comprising contacting a copper film with a gas, and raising the temperature of the copper film to about 1000° C. over of period of about 40 minutes. After reaching about 1000° C., the copper film is heated at about 1000° C. for a period of about 1 hour. The copper film is contacted with a carbon-containing gas for about 5 minutes. Finally the copper film is cooled to room temperature to produce a graphene layer on the copper film.

Another aspect of the invention involves a method for preparing a copper film to catalyze graphene production. The method involves washing the copper film with a solvent followed by adding the copper film to a mixture of ethylene glycol and acid in water. A cathode plate is added to the mixture and connected to a negative electrode. Similarly, the copper film is connected to a positive electrode and a current is passed between the cathode plate and the copper film. The copper film is removed and cleaned with water.

Yet another aspect of the invention involves a method for making graphene, comprising cleaning a copper film with a solvent and adding the copper film to a mixture of ethylene glycol and acid in water. A cathode plate is added to the mixture and connected to a negative electrode. The copper film is connected to a positive electrode and a current is passed between the cathode plate and the copper film. The copper film is removed and cleaned with water to produce a polished copper film. The polished copper film is contacted with a gas comprising hydrogen and argon. The temperature of the copper film is increased to about 1000° C. over of period of about 40 minutes, after which the temperature of the copper film is maintained at about 1000° C. for a period of about 1 hour. The copper film is contacted with a carbon-containing gas for 5 minutes and cooled to room temperature under an atmosphere of hydrogen and argon, resulting in a graphene layer on the copper film.

### BRIEF DESCRIPTION OF THE DRAWINGS

The present invention is described in the detailed description which follows, in reference to the noted plurality of drawings by way of non-limiting examples of exemplary embodiments of the present invention.

FIG. 1 shows Scanning Electron Microscopy images of graphene prepared according to the method of the present invention;

FIG. 2 shows an Atomic Force Microscopy image of graphene prepared according to the method of the present invention; and

FIG. 3 shows a flow chart for preparing graphene according to the method of the present invention.

### DETAILED DESCRIPTION OF THE INVENTION

The invention relates to nanotechnology and nanofabrication. More particularly, the invention relates to nanofabrication of few-crystal hexagonal graphene, e.g., five (5) layers. Specifically, the present invention involves chemical vapor deposition of large-area few layer hexagonal graphene on a copper film. This technique is more suitable for a larger-scale production of graphene than techniques like mechanical exfoliation.

The present invention demonstrates the preparation of large-grain, few-crystalline graphene hexagons based on carbon. Advantageously, the present invention provides a short time growth method (e.g., on the order of five minutes) to grow large-grain, few-crystalline graphene with controlled grain morphology and grain size up to 100 microns (μm). Such large graphene few crystals can find application in electronic devices, photonics, photovoltaics, and energy generation and storage.

The method involves establishing an insulating layer on a substrate such that at least one seed region, which exposes a surface of the substrate, is formed. A seed material in the seed region is exposed to a carbon-containing precursor gas, thereby initiating nucleation of the graphene layer on the seed material and enabling lateral growth of the graphene layer along at least a portion of the surface of the insulating layer. Controlled growth of graphene hexagons has been achieved by varying the growth pressure and the methane to hydrogen ratio and growth time. Also, the present invention is able to achieve graphene growth with very short exposure to a carbon source.

Surprisingly, a Scanning Electron Microscopy (SEM) study revealed that the graphene morphology had little correlation with the crystalline orientation of the underlying copper substrate. The inventive short-time method provides a viable way for large-grain few-crystalline graphene hexagon synthesis for potential high-performance graphene-based electronics.

The present invention relies on a chemical vapor deposition method for creating a graphene film. Graphene is grown by introducing a vapor carbon supply source to a copper film at elevated temperature. The copper film can be formed on a substrate. In embodiments, the copper film can take the form of a copper foil which is placed on the substrate. The copper film could also be formed on the substrate using thermal evaporation, electrochemical deposition, or sputtering. The solubility of carbon in copper is very low (on the order of ppm even at high temperature), which makes it a unique catalytic metal surface for producing graphitic structures. The carbon precursor thus forms directly on the copper surface during graphene growth.

The substrate can be an insulating substrate, for example, quartz. In other embodiments, the substrate can be a dielectric material. The substrate can come in a variety of forms, for example a tubular structure. The atmosphere can be one of a buffer gas, for example argon, to avoid the deposition of amorphous carbon. The atmosphere for graphene formation can also be one of hydrogen as well as the buffer gas. The hydrogen may serve as an activator of surface-bound carbon that leads to monolayer growth and as an etching reagent that controls the size and morphology of the resulting graphene domains. Thus, the hydrogen amounts can have an effect on the graphene formation and growth.

The presence of hydrogen during the temperature ramp up from ambient may also help avoid the oxidation of copper at elevated temperatures. The present invention can utilize a ratio of hydrogen to buffer gas, e.g., argon, of about 3:10, based on volume, for example. An example of a flow rate of argon is 100 standard cubic centimeters per minute (SCCM) and an example of a flow rate of hydrogen is 30 SSCM. The pressure utilized can be atmospheric pressure, for example.

The process itself can take place in whatever environment allows for the control of the conditions according to the method of the present invention. For example, the process can be carried out inside a conventional chemical vapor deposition chamber or multiple chambers.

The temperatures and temperature profiles used to carry out the graphene synthesis are also significant. The present invention can utilize a steady temperature ramp from ambient to about 1000° C. over a period of about 40 minutes. Copper film can contain a thin layer of native copper oxide, which is undesirable for graphene growth. Therefore, the copper film is annealed at 1000° C. for about 1 hour. The reasons for annealing are to remove the native copper oxide by reduction with H₂ and to increase the grain size of polycrystalline copper foil.

After annealing, the carbon-containing vapor, e.g., methane, is introduced. The ratio of carbon-containing vapor to the buffer gas can be about 1:2 by volume or less. Surprisingly, the present invention can achieve large-grain graphene growth with low methane flow rates, making it easier and cheaper to carry out the process on a commercial scale. For example, flow rates of methane of less than 50 SCCM, e.g., 30 SCCM, can be used in the present invention. Further, the present invention can achieve large-grain graphene growth in a fairly short growth period, making the process efficient. Specifically and advantageously, the carbon-containing vapor is introduced for a graphene growth period of about 5 minutes and more preferably exactly 5 minutes.

The foil, substrate, and newly formed graphene are then cooled down to ambient temperature using buffer gas and/or hydrogen. In embodiments, the flow rates of the buffer gas and the hydrogen gas are maintained during the cooling step and/or throughout the process. In other embodiments, the flow rates of the buffer gas and/or hydrogen are reduced while the carbon-containing gas is introduced. For example, flow rates of the buffer gas and/or hydrogen can be 30 SCCM H₂ and 100 SCCM Ar.

After the graphene is at or near ambient conditions, it can be recovered and/or transferred to another substrate. This can be accomplished by etching in any acid, Raman or PMMA method, for example. Raman spectra of the resulting product indicates that the graphene hexagons have high quality few-layer graphene with grain size of up to 100 μm.

In accordance with aspects of the invention, prior to its use to catalyze the formation of graphene, the copper film, e.g., copper foil, can be polished to aid in the production of large-grain few-crystalline graphene. First, all sides of the film are cleaned using an appropriate solvent, such as isopropyl alcohol. Next, ethylene glycol and phosphoric acid are combined in a mixture with water, preferably deionized. In embodiments, the phosphoric acid concentration in the mixture is about 0.1 molar and the ethylene glycol concentration in the mixture is about 0.1 molar. A cathode plate, for example one made of platinum, is placed in the mixture and connected to a negative electrode while the copper film is introduced to the mixture and connected to a positive electrode. A current is passed between the cathode plate and the copper film, for example 2 mA for 15 minutes. Finally the copper film is cleaned again with deionized water to prevent oxidation.

### EXAMPLES

The following example is provided by way of illustration and is not intended to be exhaustive or otherwise limiting to the claimed invention.

Large-grain, few-crystalline graphene of hexagonal shape was achieved by using a chemical vapor deposition method as described herein. Commercially obtained copper foil was first prepared by polishing according to the following procedure:

Step 1: All sides of the foil were cleaned using isopropyl alcohol.

Step 2: Ethylene glycol and phosphoric acid were combined in deionized water.

Step 3: A platinum plate and the copper foil were put in the acidic aqueous mixture and the platinum plate was connected to a negative electrode while the copper foil was connected to a positive electrode.

Step 4: A 2 mA current was passed between the cathode plate and the copper foil for 15 minutes.

Step 5: The copper foil was removed and rinsed with deionized water.

After the copper foil was polished, it was dried, rolled up and put into a ½ inch diameter small quartz tube. The quartz tube containing the copper foil was then placed inside a chemical vapor deposition (CVD) chamber. 30 standard cubic centimeters per minute (SCCM) of H₂ and 100 SCCM of Ar were introduced to the CVD chamber at atmospheric pressure. The temperature of the chamber was then increased to 1000° C. over a period of 40 minutes. The copper foil was annealed at the 1000° C. temperature for 60 minutes. 50 SCCM of CH₄ gas was then introduced into the CVD chamber for 5 minutes. After the 5 minutes, the CVD chamber was cooled down to room temperature with the flow of 30 SCCM H₂ and 100 SCCM Ar continuing.

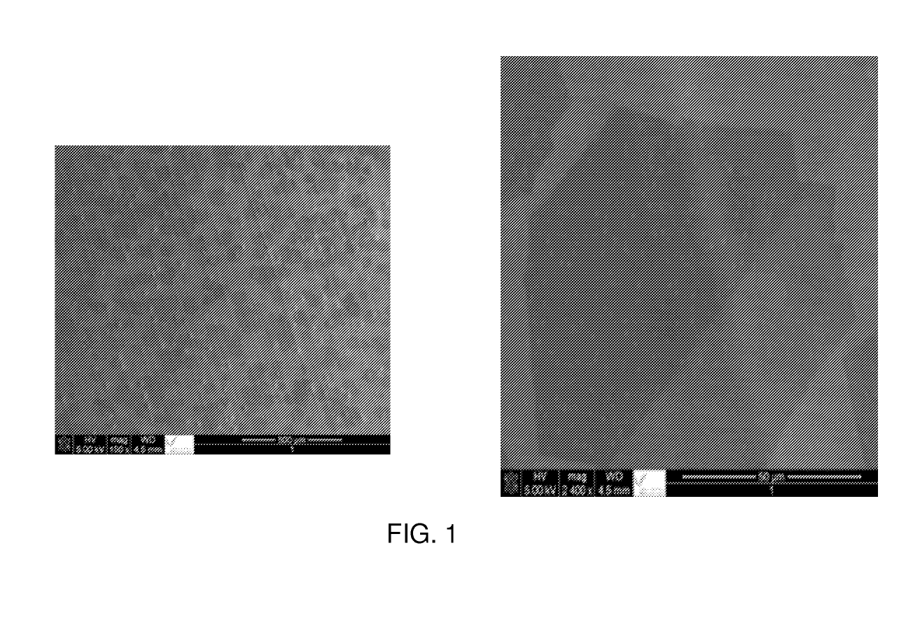

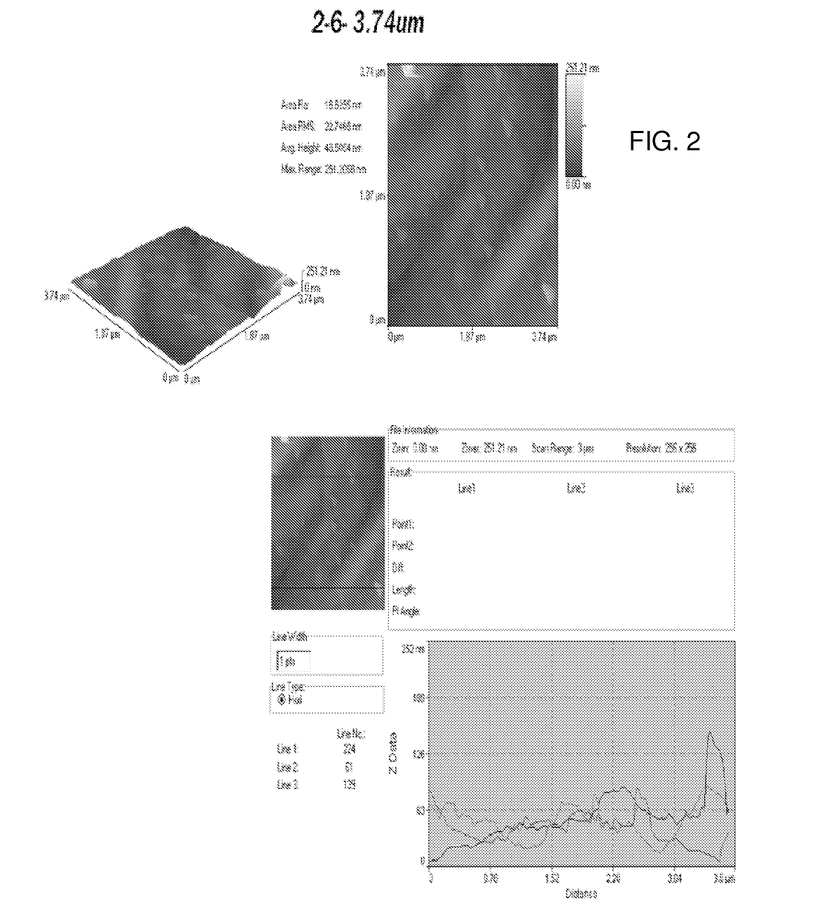

The resulting graphene layer was collected and analyzed. As is evident from FIG. 1, which shows two scanning electron microscopy (SEM) images of graphene made using the method of the present invention, the inventive method results in large-grain, few-crystalline graphene. The scales included with the micrographs in FIG. 1 give an indication of the sizes of the grains, which are on the order of 100 μm, as previously described herein. The large, few-crystalline graphene grains (i.e., five (5) layers) are also evident in FIG. 2, which is an atomic force microscopy image of graphene produced according to the inventive method described. FIG. 2 calculates an average height for the grains of less than 100 nm and more accurately at about 49 nm and even more accurately at about 48.5 nm. More specifically, referring to both FIG. 1 and FIG. 2, the present invention was able to achieve a large-grain, few-crystalline graphene with controlled grain morphology. The grain size of hexagons shape grains can achieve more than 100 μm with high quality few-layer graphene as mono and bilayer graphene as centers.

### Flow Diagram

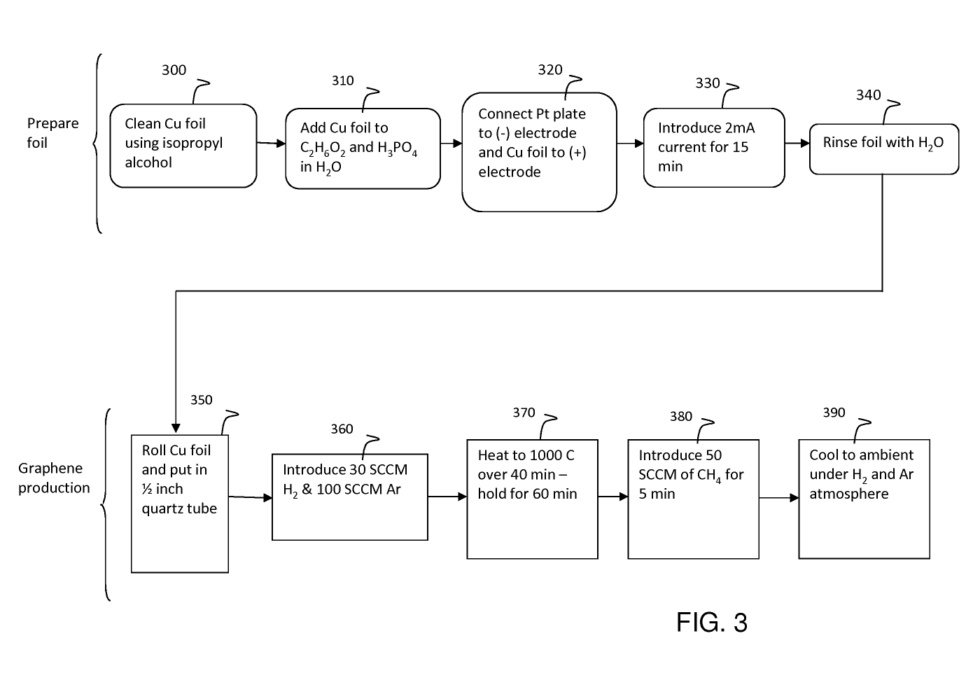

Embodiments of the inventive method are described in terms of a flow diagram to aid in its understanding. FIG. 3 shows an embodiment of the present invention in terms of a flow diagram starting from preparing a copper film to producing graphene using the film. More specifically, the first sequence shown in FIG. 3 is the preparation of the copper foil. As shown in step 300, the copper foil is cleaned using a solvent such as isopropyl alcohol. Next, the copper foil is added to a combination of ethylene glycol and phosphoric acid in deionized water, as indicated in step 310. Step 320 shows that the copper foil in the mixture is connected to a positive electrode while a platinum plate in the same mixture is connected to a negative electrode. In step 330, a current is introduced. For example, the current can be applied for 15 minutes at 2 V and 0.12 amps. Finally, in step 340, the copper foil is rinsed with deionized water to prevent oxidation.

After the foil is prepared, FIG. 3 shows that the foil is used for graphene production. In step 350, the copper foil is rolled and placed inside a quartz tube, described in the embodiment of step 350 as ½ inch in diameter. Step 360 shows the introduction of 30 SCCM of hydrogen and 100 SCCM of Argon. In step 370, the materials are heated to 1000° C. over a period of about 40 minutes and then held at 1000° C. for about 60 minutes. In step 380, 50 SCCM of methane is introduced for a period of five minutes, after which, the copper foil and newly formed graphene are cooled to ambient temperature under a hydrogen and argon atmosphere, as shown in step 390.

The foregoing example and flow diagram have been provided for the purpose of explanation and should not be construed as limiting the present invention. These examples show that it is possible to commercially fabricate graphene on short time, e.g., 5 minutes, with reduced flow and temperature. While the present invention has been described with reference to an exemplary embodiment, changes may be made, within the purview of the appended claims, without departing from the scope and spirit of the present invention in its aspects. Also, although the present invention has been described herein with reference to particular materials and embodiments, the present invention is not intended to be limited to the particulars disclosed herein; rather, the present invention extends to all functionally equivalent structures, methods and uses, such as are within the scope of the appended claims.

What is claimed is:

1. A method for making graphene, comprising:
contacting a copper film with a gas;
raising a temperature of the copper film to about 1000° C. over of period of about 40 minutes;
heating the copper film at about 1000° C. for a period of about 1 hour;
contacting the copper film with a carbon-containing gas for about 5 minutes; and
cooling the copper film to room temperature to produce a graphene layer on the copper film.

2. The method of claim 1, further comprising placing the copper film in a quartz tube prior to contacting the film with the gas.

3. The method of claim 1, wherein the steps of claim 1 are provided in a chemical vapor deposition (CVD) chamber.

4. The method of claim 1, wherein the gas comprises hydrogen and argon in a ratio of about 3:10 by volume.

5. The method of claim 4, wherein a flow rate of hydrogen in the gas is about 30 standard cubic centimeters per minute at atmospheric pressure and a flow rate of argon in the gas is about 100 standard cubic centimeters per minute at atmospheric pressure.

6. The method of claim 5, further comprising introducing methane for about 5 minutes at a flow rate of 50 standard cubic centimeters per minute.

7. The method of claim 1, wherein the gas comprises hydrogen and argon and their flow rates remain unchanged throughout the method.

8. The method of claim 1, wherein the cooling of the copper film to room temperature is provided under an atmosphere of hydrogen and argon.

9. A method for preparing a copper film to catalyze graphene production, comprising:
washing copper film with a solvent;
adding the copper film to a mixture of ethylene glycol and acid in water;
adding a cathode plate to the mixture and connecting the cathode plate to a negative electrode;
connecting the copper film to a positive electrode;
passing a current between the cathode plate and the copper film; and
removing the copper film and cleaning the copper film with water.

10. The method of claim 9, wherein the solvent is isopropyl alcohol.

11. The method of claim 9, wherein the cathode plate comprises platinum.

12. The method of claim 9, wherein the current passed is about 2 mA.

13. The method of claim 9, wherein the current is maintained for about 15 minutes.

14. The method of claim 9, wherein the phosphoric acid concentration in the mixture is about 0.1 molar and the ethylene glycol concentration in the mixture is about 0.1 molar.

15. The method of claim 9, wherein the water is deionized.

16. A method for making graphene, comprising:
cleaning a copper film by washing with a solvent;
adding the copper film to a mixture of ethylene glycol and acid in water;
passing a current between a cathode plate and the copper film; and
cleaning the copper film with deionized water to produce a polished copper film;
contacting the polished copper film with a gas comprising hydrogen and argon;
increasing the temperature of the copper film to about 1000° C. over of period of about 40 minutes;
maintaining a temperature of the copper film for a period of about 1 hour;
contacting the copper film with a carbon-containing gas for 5 minutes; and
cooling the copper film to room temperature under an atmosphere of hydrogen and argon to produce a graphene layer on the copper film.

17. The method of claim 16, further comprising placing the polished copper film in a quartz tube prior to contacting the film with a gas.

18. The method of claim 16, wherein the gas comprises hydrogen and argon in a ratio of about 3:10 by volume.

19. The method of claim 16, wherein flow rates of hydrogen and argon remain unchanged throughout the method.

20. The method of claim 16, wherein the temperature is maintained at about 1000° C.
